(19) United States
(12) Patent Application Publication
(10) Pub. No.: US 2014/0160968 A1
(43) Pub. Date: Jun. 12, 2014

(54) Enhanced Use of Frequency Spectrum in a Wireless Communication Network

(71) Applicants: Henrik Sahlin, Molnlycke (SE); David Engdal, Torslanda (SE); Anders Persson, Kode (SE); Yi-Pin Eric Wang, Fremont, CA (US)

(72) Inventors: Henrik Sahlin, Molnlycke (SE); David Engdal, Torslanda (SE); Anders Persson, Kode (SE); Yi-Pin Eric Wang, Fremont, CA (US)

(73) Assignee: TELEFONAKTIEBOLAGET L M ERICSSON (PUBL), Stockholm (SE)

(21) Appl. No.: 14/130,596

(22) PCT Filed: Jul. 4, 2011
(86) PCT No.: PCT/EP2011/061176

§ 371 Date: Jan. 2, 2014

(51) Int. Cl. H04W 24/08; H04W 24/10

(52) U.S. Cl. CPC H04W 24/08; H04W 24/10
USPC 370/252

(57) ABSTRACT

The present invention relates to a user terminal (1) arranged for communication with at least one node (2) in a wireless communication network (3). The user terminal (1) is arranged to measure received signal characteristics from at least one other user terminal (4, 5) when it is transmitting signals (6, 7; 8, 9). The measured received signal characteristics are comprised in measurement data. The user terminal (1) is arranged to transfer the measurement data to said node (2) at certain times. The present invention also relates to a node (2) that is arranged to schedule transmission and reception of signals such that each user terminal (1, 4, 5) that communicates via the node (2) either transmits or receives signals to/from the node (2) at a first frequency interval. The node (2) is arranged to transmit and receive signals simultaneously at the first frequency interval. The present invention also relates to a method.

### TECHNICAL FIELD

The present invention relates to a user terminal arranged for communication with at least one node in a wireless communication network.

The present invention also relates to a node in a wireless communication network.

The present invention also relates to a method in a wireless communication network.

### BACKGROUND

In recent years, technologies such as OFDM (Orthogonal frequency-division multiplexing) and MIMO (Multiple Input Multiple Output) have been applied in order to increase the spectral efficiency of wireless communication systems. However, with continuously increasing demands on wireless communication bandwidth, the search for higher spectral efficiency is essential.

In the Long Term Evolution (LTE) of 3GPP (3^{rd} Generation Partnership Project), a new flexible air interface is being standardized. The LTE system will provide spectrum flexibility in the sense that varying carrier bandwidths between 1.25 MHz and 20 MHz can be handled, and both FDD (Frequency Division Duplex) and TDD (Time Division Duplex) will be supported in order to be able to use both paired and unpaired spectrums. LTE is expected to be a smooth evolution path for 3G standards such as WCDMA (Wideband Code Division Multiple Access), TD-CDMA (Time Division—Code Division Multiple Access) and TD-SCDMA (Time Division—Spatial Code Division Multiple Access). LTE is also expected to offer significant performance improvements as compared current 3G standards by using for example various advanced antenna techniques.

In a wireless system for mobile communication, the transmission from a base station (BS) or a similar node to a user terminal is referred to as downlink. Correspondingly, the transmission from a user terminal to a base station is referred to as uplink. In existing solutions, antennas at base stations are often used both for transmitting in downlink and receiving in uplink. Different antennas may alternatively be used for downlink and uplink.

By assigning downlink and uplink different carrier frequencies, it is possible to achieve low crosstalk between transmit and receive signals with frequency selective filters in an FDD manner. Alternatively, uplink and downlink are scheduled in different time intervals by TDD which also reduces the cross-talk. However, both these solutions require that downlink and uplink are allocated to different frequency or time intervals, resulting in an ineffective utilization of available spectrum.

There is thus a need for more enhanced wireless communication between nodes and user terminals where the available frequency spectrum is utilized in a more efficient manner.

### SUMMARY

The object of the present invention is to provide enhanced wireless communication between nodes and user terminals, where the available frequency spectrum is utilized in a more efficient manner.

This object is obtained by means of a user terminal arranged for communication with at least one node in a wireless communication network. The user terminal is arranged to measure received signal characteristics from at least one other user terminal when said other user terminal is transmitting signals. The measured received signal characteristics are comprised in measurement data. The user terminal is arranged to transfer the measurement data to said node at certain times.

According to an example, the user terminal is arranged to gather information for identification of said other user terminal, said information being comprised in the measurement data.

According to another example, the transferred measurement data enables said node to schedule its transmission of signals and reception of signals such that each user terminal that communicates via said node either transmits signals to said node at a first frequency interval or receives signals from said node at the first frequency interval. The node is arranged to transmit signals and receive signals simultaneously at the first frequency interval.

This object is also obtained by means of a node in a wireless communication network. The node is arranged to schedule its transmission of signals and reception of signals such that each user terminal that communicates via the node either transmits signals to the node at a first frequency interval or receives signals from the node at the first frequency interval. The node is arranged to transmit signals and receive signals simultaneously at the first frequency interval.

According to an example, the scheduling comprises division of the user terminals that communicate via the node into at least two groups, where at least one user terminal in a first group is scheduled to only transmit signals and at least one user terminal in a second group is scheduled to only receive signals.

According to another example, the scheduling is based on measurement data received from at least one user terminal according to the above.

According to another example, the node further comprises at least a first antenna function and a second antenna function. The antenna functions are arranged for transmitting signals and receiving signals in controllable spatial directions. Preferably, the antenna functions that are arranged to transmit signals are physically separated from those antenna functions that are arranged to receive signals.

This object is also obtained by means of a method in a wireless communication network where the method comprises the steps:

At least one user terminal in the wireless communication network measuring received signal characteristics from at least one other user terminal when said other user terminal is transmitting signals. The measured received signal characteristics are comprised in measurement data.
Transferring the measurement data to at least one node in the wireless communication network.
Using the measurement data for scheduling transmission of signals and reception of signals from and to said node such that each user terminal that communicates via said node either transmits signals to said node using a first frequency interval or receives signals from said node using the first frequency interval.
Said node transmitting signals and receiving signals simultaneously using the first frequency interval.

According to an example, the method comprises the step of dividing the user terminals that communicate via the node into at least two groups. At least one user terminal in one group is scheduled to only transmit signals and at least one user terminal in another group is scheduled to only receive signals.

Other examples are disclosed in the dependent claims.

A number of advantages are obtained by means of the present invention. For example the capacity of the available frequency spectrum will ideally be doubled compared with current wireless communications systems.

### BRIEF DESCRIPTION OF THE DRAWINGS

The present invention will now be described more in detail with reference to the appended drawings, where:

FIG. 1 shows a schematic side view of a part of wireless transmission network;

FIG. 2 shows a schematic top view of cells in a wireless transmission network;

FIG. 3 shows time slot rows for a base station and two user terminals;

FIG. 4 shows time slot rows for a base station and three user terminals;

FIG. 5 shows a schematic side view of a part of wireless transmission network where user terminals are divided into two groups;

FIG. 6 shows a schematic top view of cells in a wireless transmission network where transmitting and receiving antenna functions are spatially separated with central processing;

FIG. 7 shows a schematic top view of cells in a wireless transmission network where transmitting and receiving antenna functions are spatially separated with distributed processing; and

FIG. 8 shows a flowchart for a method according to the present invention.

### DETAILED DESCRIPTION

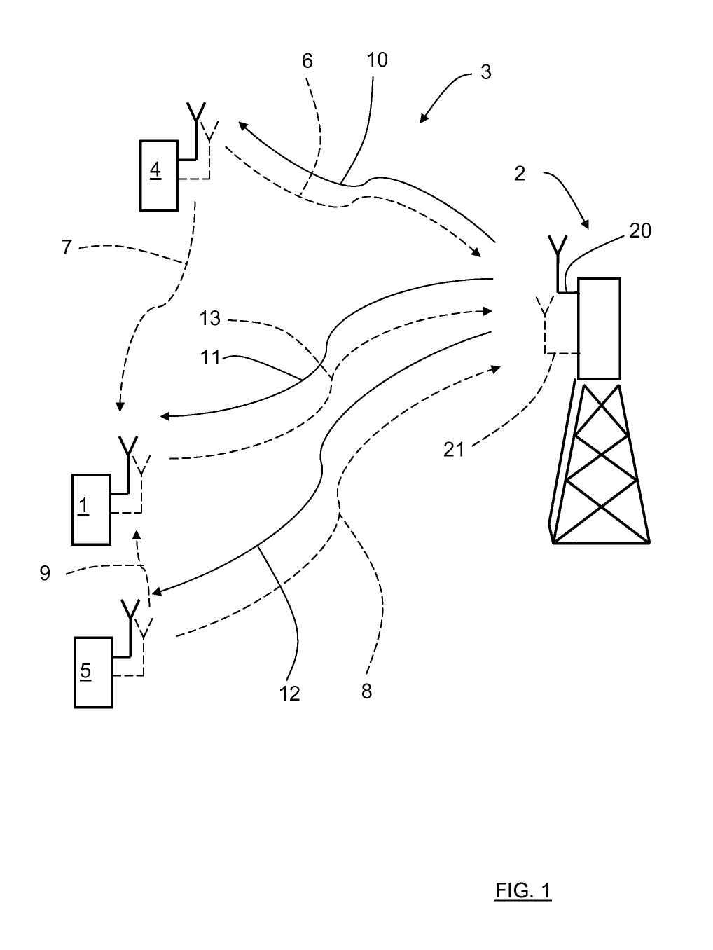

With reference to FIG. 1, in a wireless communication network 3 for mobile communication, transmission from a base station 2, or a similar node, to a user terminal 1, 4, 5 is referred to as downlink. Correspondingly, the transmission from a user terminal 1, 4, 5 to a base station 2 is referred to as uplink. Several user terminals may be scheduled to transmit simultaneously, both in downlink and uplink, typically on different frequency intervals, i.e. parts of the frequency band, in a TDMA/FDMA (Time Division Multiple Access/Frequency Division Multiple Access) fashion. At the receiver, one large FFT (Fast Fourier Transform) is taken from the output of each receiving antenna function and the user terminals are separated.

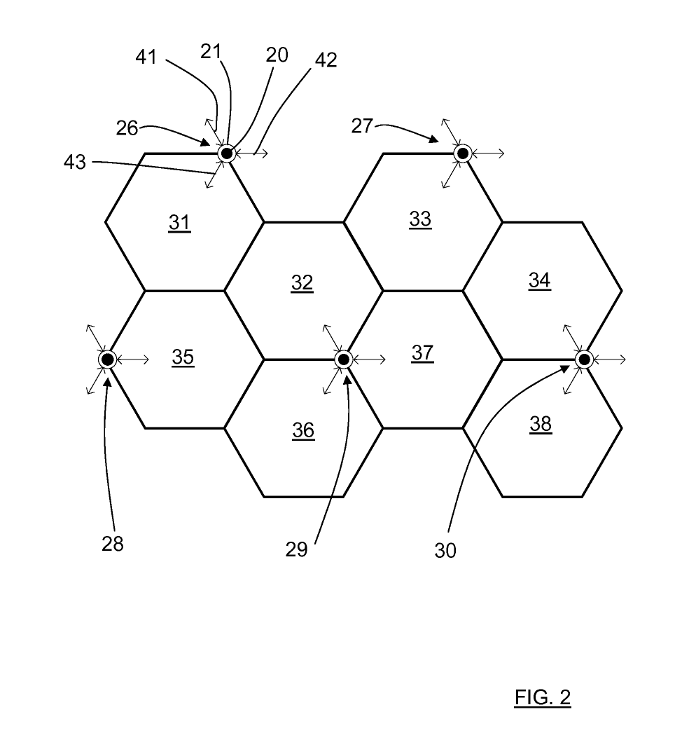

In FIG. 2, a part of a traditional cell layout in a cellular network is illustrated where several base stations 26, 27, 28, 29, 30 are placed in a geographical grid. Each base station 26, 27, 28, 29, 30 is placed in the intersection of three cells 31, 32, 33, 34, 35, 36, 37, 38. As illustrated with reference signs for a first base station 26, each base station 26, 27, 28, 29, 30 is equipped with directional antenna functions 20, 21 such that it can cover three adjacent cells. Receiving antenna functions 21 are denoted with a white circle and transmitting antenna functions 20 are denoted with a black dot, the ability for each base station to transmit and receive being indicated with double arrows 41, 42, 43. Although only denoted with reference signs for the first base station 26 for increased clarity, this configuration is applied for all base stations 26, 27, 28, 29, 30. It should be noted that there normally are more cells and base stations in a cellular network than those shown, FIG. 2 only showing a part for reasons of clarity.

Furthermore, the cells 31, 32, 33, 34, 35, 36, 37, 38 are used as illustrations of a geographical area in which user terminals are associated with a specific base station. Note that this illustration is highly idealized in that all cells have identical size and layout. In a real system, local geographical variations and user terminal density will lead to a heterogeneous cell layout.

The information in downlink and uplink has several dependencies. As an example for a user terminal and a base station which communicate with each other, acknowledge of correctly detected user data in downlink is transmitted as an uplink ACK (Acknowledge). After this ACK is detected in uplink, the base station will retransmit data on downlink if the ACK indicated that the user terminal was not able to detect user data correctly. In the same way, the uplink detector must inform the user terminal if an uplink transmission was detected correctly or not with a downlink ACK. This downlink ACK is transmitted on downlink. When the uplink scheduler is placed in the base-station, then the uplink decisions must be transmitted to the user terminal via downlink. Other examples of signaling between downlink and uplink processing in the base stations are downlink CQI (Channel Quality Indicator) measures, uplink SNR (Signal to Noise Ratio) measures, and both uplink and downlink scheduling decisions.

With reference to FIG. 1, it will now be disclosed how the frequency spectrum can be better utilized.

According to the present invention, a first user terminal 1 is arranged to communicate with a base station 2, where the first user terminal 1 also is arranged to measure received signal characteristics from a second user terminal 4 and a third user terminal 5 when the second user terminal 4 and the third user terminal 5 is transmitting signals 6, 7; 8, 9. The measured received signal characteristics are comprised in measurement data, where furthermore the first user terminal 1 is arranged to transfer the measurement data to the base station 2 at certain times.

The measurement data comprises several parameters, for example information for identification of the second user terminal 4 and the third user terminal 5.

Two examples of how the first user terminal 1 measures received signal characteristics are disclosed below:

In the first example, the identity of the transmitting other user terminals 4, 5 can be derived by the first user terminal 1 from control channels in downlink. The first user terminal 1 measures reference signals from other user terminals 4, 5 and estimates interference levels from them. Then these interference levels from each other user terminal 4, 5 are reported to the base station 2.

In the second example, the first user terminal 1 measures interference levels in all, or at least one, TTI:s (Transmission Time Interval) and report to the base station 2 in which TTI:s that the interference is high or low. Since the base station has knowledge of which user terminals that were transmitting during these TTI:s, the base station 2 also has knowledge of which user terminals that were causing interference in these TTI:s.

With several receiving antennas in user terminals, knowledge of the spatial and temporal characteristics of the radio channel between the user terminals can be used to further improve performance. Then the difference in spatial and temporal characteristics between the signal from a user terminal transmitting in uplink and the signal received from the base-station transmitting simultaneously in downlink puts limits on the how accurate the downlink channel can be detected. Thus, not only the signal level from the other user terminals 4, 5 should be reported to the base station 2, but also how well the first user terminals 1 can exploit the spatial and temporal dimensions. With both SU-MIMO (Single User-MIMO) and MU-MIMO (Multi User-MIMO) this is even more important.

This means that, preferably, the signal characteristics are constituted by at least one of signal strength, signal spatial characteristics and signal temporal characteristics.

The measurement data may be used in several ways, for example for self-configuration of the first user terminal 1.

In a specially preferred example of the present invention, at the base station 2, the transferred measurement data is used to schedule its transmission of signals 10, 11, 12 and reception of signals 6, 8, 13 such that each user terminal 1, 4, 5 that communicates via the base station 2 either transmits signals 6, 8, 13 to the base station 2 at a first frequency interval or receives signals 10, 11, 12 from the base station 2 at the first frequency interval.

Also according to the present invention, the base station 2 is at the same time arranged to transmit signals 10, 11, 12 and receive signals 6, 8, 13 simultaneously at the first frequency interval.

This means that the base station 2 is arranged to schedule its transmission of signals 10, 11, 12 and reception of signals 6, 8, 13 in the above manner and in this case, the present invention provides a full duplex system solution where each base station 2 can transmit and receive on downlink and uplink simultaneously, using the same frequency interval. Each individual user terminal 1, 4, 5 uses time division duplex.

However, if a base station 2 is transmitting and receiving simultaneously in the same time and frequency interval, the cross-talk between transmitting antenna functions 20 and receiving antenna functions 21 may cause a problem. By spatially separated transmitting and receiving antenna functions, this cross-talk is reduced.

With a vertical separation of the antenna functions, see schematic illustration in FIG. 1, these can be placed on the same mast but simply on different distances from the ground level. More specifically, the antenna functions 20 that are arranged to transmit signals 10, 11, 12 are physically separated from those antenna functions 21 that are arranged to receive signals 6, 8, 13.

The antenna functions can also be separated horizontally. In both cases, the antenna patterns of both transmitting antenna function and receiving antenna functions should be designed such that the cross-talk is as small as possible. If the separation between transmitting antenna function and receiving antenna functions is in the same magnitude as the distance from the base-station transmitting antenna functions and receiving antenna functions to a user terminal, then the path loss will furthermore reduce the cross-talk.

Spatially separated transmitting antenna functions and receiving antenna functions prevents the uplink receiver ND (Analogue/Digital) converted from being saturated by the downlink interference. As such, both the downlink interference signal and uplink useful signal are preserved with good fidelity in the digital baseband.

Simultaneous transmit and receive in the same frequency interval is theoretically applicable both on the user terminal and base station side. However, due to the smaller physical size of a typical user terminal, spatially separated transmit and receive antennas seems less tractable on the terminal side compared to the base station side.

In accordance with the present invention, a preferred arrangement comprises user terminals 1, 4, 5 which switch between transmit and receive while the base station 2 simultaneously can transmit and receive with its spatially separated antenna functions 20, 21, such that it can alternate its transmissions to different user terminals 1, 4, 5. Typically this is done in a time division manner such that while transmitting to some user terminals in the downlink, the base station 2 is receiving uplink signals from other user terminals. In this example, the base station 2 controls which user terminals that transmit on the uplink and receive on downlink in a given TTI with fast RRM (Radio Resource Management).

Preferably, a slot format is designed such that the user terminals 1, 4, 5 work in a TDD (Time Division Duplex) manner. Here the time and frequency allocations in which a user terminal transmits and receives must be carefully designed both for payload and control signaling.

In a cellular network, the downlink transmission in one cell will impact the uplink received signal in both the same and in other cells. This interference can be suppressed by using for example beam-forming or interference cancellation, which will be discussed more in detail later.

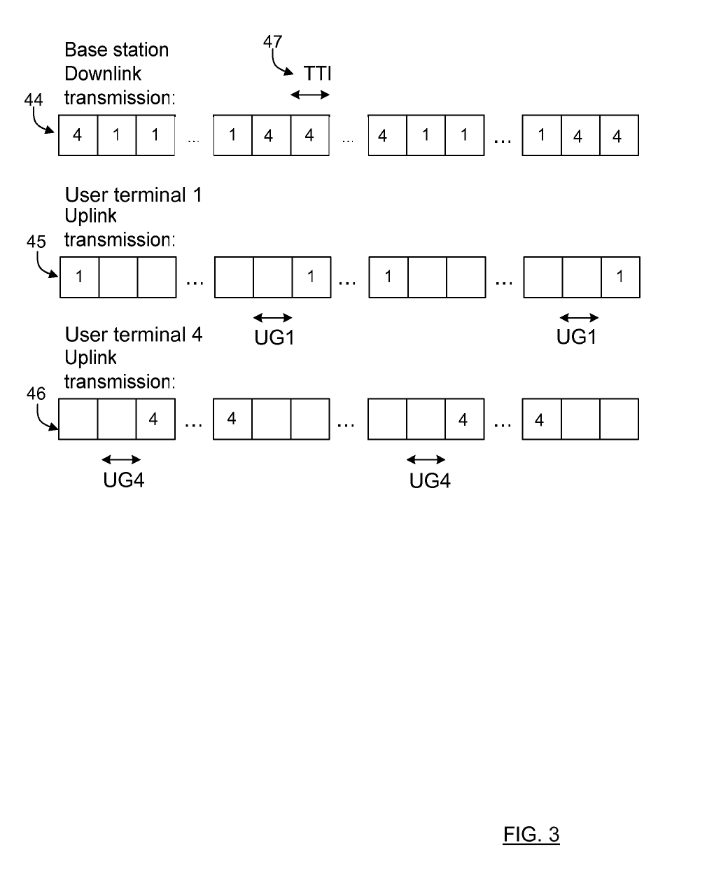

An example of a slot format with two user terminals such as the first user terminal 1 and the second user terminal 4 is illustrated in FIG. 3. A first time slot row 44 indicates base station downlink transmission, and the numbers in the slots indicate with user terminal that the base station 2 transmits to. A second time slot row 45 indicates uplink transmission for the first user terminal 1 and a third time slot row 46 indicates uplink transmission for the second user terminal 4, and the numbers in the slots indicate which user terminal that transmits to the base station 2.

A special TTI 47 is included in which the user terminals 1, 4 are switching from receiving and transmitting. User terminal guard slots UG1, UG4 are included at this switching.

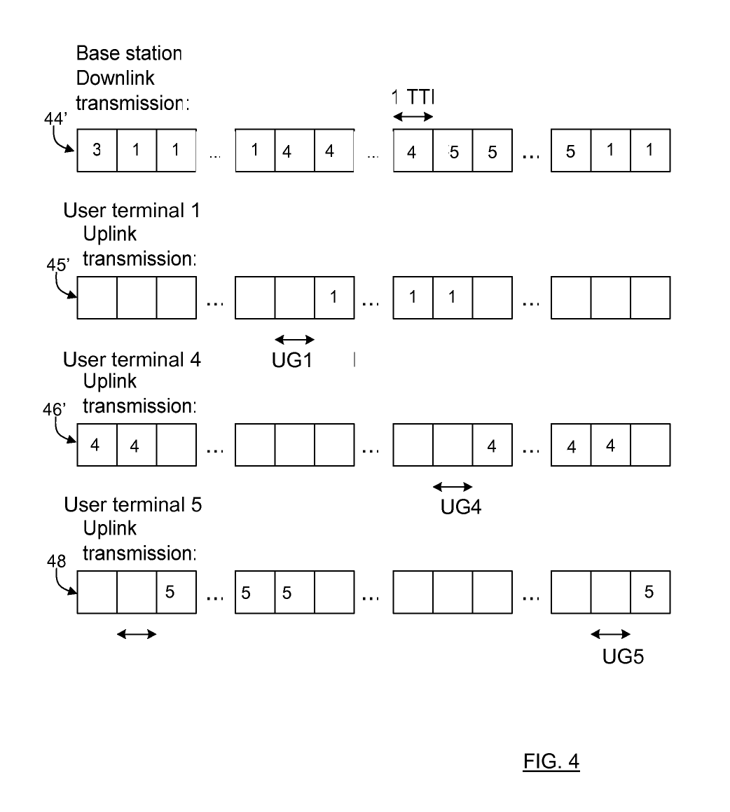

If more than two user terminals are scheduled, this special TTI can be excluded as illustrated in FIG. 4 with a corresponding first time slot row 44′, second time slot row 45′, third time slot row 46′ and a fourth time slot row 48, where the numbers in the slots in the fourth time slot row 48 indicate when the third user terminal 5 transmits to the base station 2. Thus, the special sub-frames, as specified for the so-called frame structure type 2, which is applicable for TDD in 3GPP (3^{rd} Generation Partnership Project) LTE (Long Term Evolution), are not needed.

Compared to conventional TDD where a system-wide static partitioning between uplink and downlink is made, simultaneous transmit and receive in the same frequency interval enables a flexible user terminal specific partitioning. This is possible as the downlink transmission does not have to be interrupted during uplink transmission. The slot format should be designed to handle this.

As an example, it is possible to transmit on downlink to a certain user terminal for M consecutive TTI:s—in parallel, uplink data is received from other user terminals—and schedule the certain user terminal to transmit on uplink for the next N TTI:s. In this way, a downlink-to-uplink ratio of M/N is achieved. By increasing M, the downlink peak-rate can be nearly doubled compared to conventional TDD with a 50/50 partitioning. Alternatively, by increasing N, uplink peak-rate can be nearly doubled. However, delay sensitivity information, e.g., HARQ (Hybrid Automatic Repeat Request) ACK/NACK (Acknowledge/No Acknowledge), puts an upper limit on M and N in practice as feedback for a first downlink TTI 1 can be sent first in uplink TTI M+1.

Note that M and N can be configured differently for different user terminals to reflect the specific capacity needs at the moment for a certain user terminal. This means that the downlink-to-uplink ratio can be controlled on a per user terminal basis by the RRM.

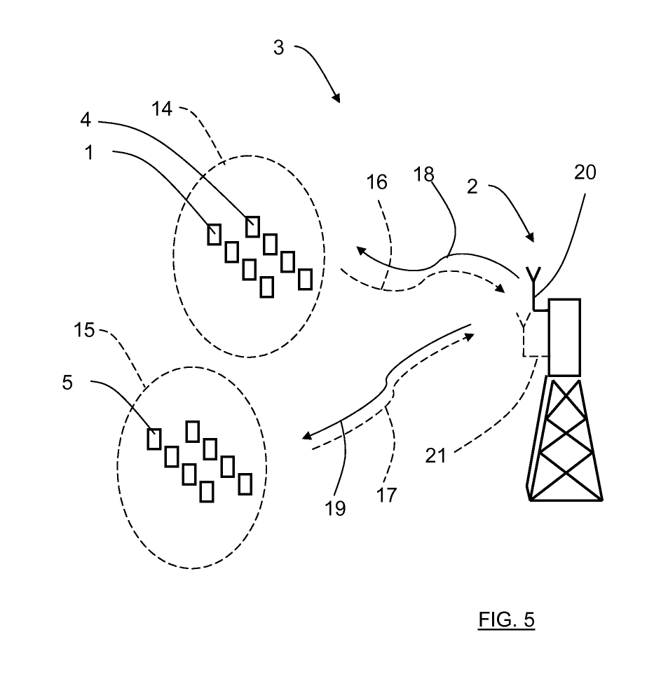

According to another example, the user terminals are divided into at least two groups which alternate between transmitting and receiving. The RRM will have the intricate task of dividing the user terminals into these groups. Thus, with reference to FIG. 5, the scheduling comprises division of the user terminals that communicate via the node into two groups 14, 15, where, in a first mode, at least one user terminal 1, 4 in a first group 14 is scheduled to only transmit signals 16 and at least one user terminal 5 in a second group 15 is scheduled to only receive signals 19. In a second mode, at least one user terminal 1, 4 in the first group 14 is scheduled to only receive signals 18 and at least one user terminal 5 in the second group 15 is scheduled to only transmit signals 17.

The base station 2 is arranged to adjust the transmitted downlink power for correct detection in the user terminal while at the same time not causing too much interference at the base station receiving antenna function 21 for uplink.

According to the example, the first user terminal 1 will receive on downlink while the second user terminal 4 is simultaneously transmitting on the uplink. The uplink signal transmitted from the second user terminal 4 will constitute interference for the first user terminal 1 which is receiving on the downlink. By power control in both the transmitting user terminal and in the base station 2, the SINR (Signal to Interference and Noise Ratio) in the receiving first user terminal 1 can be adjusted. The transmitting second user terminal 4 is arranged to adjust its uplink transmitted power such that another user terminal, such as the first user terminal 1, can detect a received downlink signal simultaneously. The base station 2 is also arranged to adjust its transmitted downlink power such that the first user terminal 1 can detect the received signal in the presence of interference from the second user terminal 4 transmitting on uplink.

The RRM decides which pairs of user terminals which can transmit and receive simultaneously. This must be based on knowledge of the channels between user terminals. With the assumption that the RRM functionality is placed in the base-station 2, some knowledge of the channels between the first user terminal 1 and the other user terminals 4, 5 must be transferred from the first user terminal 1 to the base-station 2, and this is provided according to the measurements performed by the first user terminal 1 as described previously.

In the following, further examples of other additional techniques that may be used together with the present invention, either alone or together with other disclosed additional techniques will now be described.

Beam-forming is a technique in which several antenna elements are used together in transmission of a signal such that the transmitted power is different in different spatial directions and to different spatial positions. The transmitted signal from the base-station can thus be directed towards the spatial direction or position in which a user terminal is placed. Also, the power can be reduced in the direction and position of a base station uplink receiving antenna which is done by placing an antenna radiation beam null in that direction or position. The receiving antenna in the base-station can also be constructed with several antenna elements and can thus be arranged to place a null in the direction and position of the downlink transmitting antenna in the base-station.

The channel between transmit and receive antennas of a base station 2 is not time varying, or at least very slowly time varying, such that stationary beam-forming can be used. Two alternative ways of selecting beam-forming are given below. The beam-forming is parameterized by complex valued scaling factors, so-called antenna weights, which are applied to the signals before transmitted from the antenna elements.

In the first alternative, transmit and where applicable receive antenna weights are selected based on known direction to receive and transmit antennas and by exact knowledge of corresponding antenna array geometries. An antenna array geometry can be acquired by means of calibration.

In the second alternative, the channel between transmit and receive antennas is estimated. This channel is probably very slowly fading. Channel estimation can be done by utilizing the known reference signals which are transmitted in downlink on specific time and frequency positions. In one possible version of the channel estimation algorithm, the receiver has information regarding the whole transmitted signal and thus has very many signals to use as reference.

When estimating the channel from downlink transmitter to uplink receiving antenna, the uplink signals will act as interference and introduce errors in the channel estimates. By averaging over a relatively long time, these errors can be reduced if the correlation between the downlink and uplink signals is zero valued. Alternatively, the slot format in uplink can be designed such that there is no transmission in uplink for a few time and frequency intervals. Interference cancellation can also be used to improve the estimate of the channel from downlink transmitter to uplink receiving antenna. If the uplink signal is decoded error free, most of its contribution to the received signal can be removed. This will allows a channel estimator to observe the downlink signals with very little interference.

The beam-forming at a transmitter and a receiver can be slow or fast time varying. Slow time varying beam-forming can be due to slowly updating beam-forming parameters when user terminals are moving or channel estimates are changing. A fast time varying beam-forming can occur if switches occur between different beam-forming patterns for different sets of user terminals. When estimating the channel between transmitting and receiving antennas, these aspects of time varying beam-forming must be considered.

Another additional technique is interference cancellation which can be used in a baseband in order to suppress interference from the transmitted downlink signal in uplink received signal. This interference signal can be detected if non centralized processing is used. On the other hand, for the case of centralized processing, the transmitted signal is known, which simplifies and improves the interference cancellation.

For 3GPP LTE, this interference cancellation architecture thus aims at cancelling OFDM (Orthogonal Frequency-Division Multiplexing) signals, i.e. downlink signals, from an SC-FDMA (Single Carrier—Frequency Division Multiple Access signal, i.e. an uplink signal. SC-FDMA may also be referred to as pre-coded OFDM. Preferably, this interference cancellation is done before any other of the baseband algorithms such as uplink channel estimation, equalization and detection.

Another additional technique is the previously mentioned spatial separation of transmitting antenna functions and receiving antenna functions at a base station where these antenna functions still are positioned at the same site.

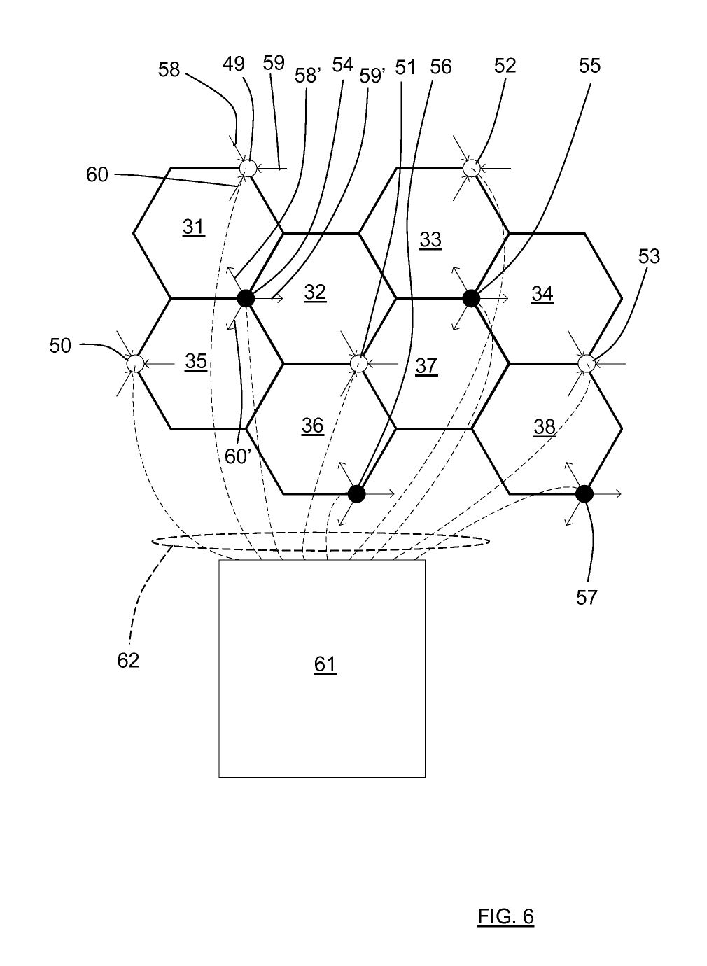

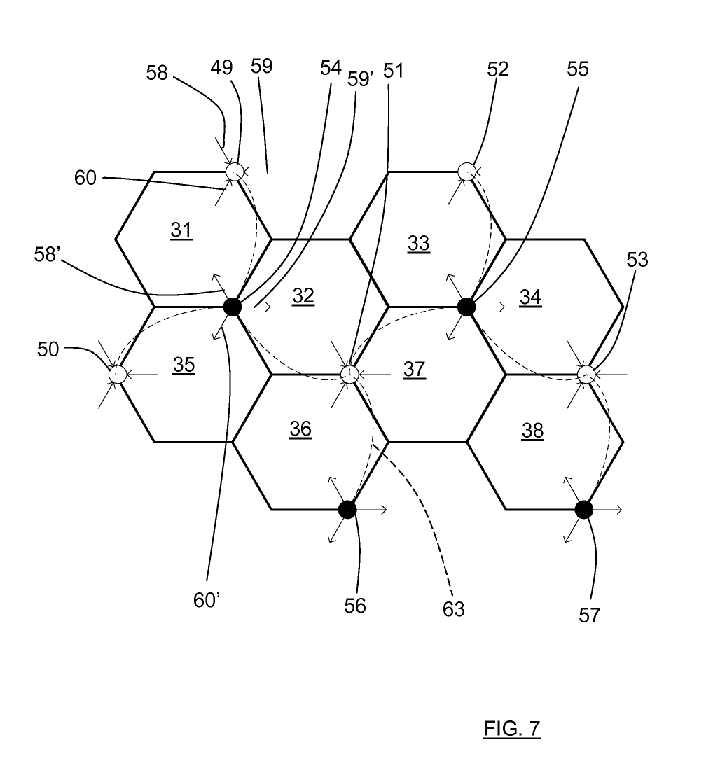

As an alternative spatial separation of transmitting antenna functions and receiving antenna functions, a cell layout example is given in FIG. 6 and FIG. 7 where an enhanced separation for transmitting antenna functions and receiving antenna functions is shown. FIG. 6 and FIG. 7 generally correspond to FIG. 2, where FIG. 2 shows a traditional cell layout in a cellular network.

In FIG. 6 and FIG. 7 a number of cells 31, 32, 33, 34, 35, 36, 37, 38 as in FIG. 2 are shown. Receiving antenna functions 49, 50, 51, 52, 53, denoted with a white circle, and transmitting antenna functions 54, 55, 56, 57, denoted with a black dot, are placed in a geographical grid such that they are placed in the intersection of three cells 31, 32, 33, 34, 35, 36, 37, 38. At each such intersection there is either a receiving antenna function 49, 50, 51, 52, 53 or a transmitting antenna function 54, 55, 56, 57, such that en enhanced spatial separation is accomplished.

The receiving ability for the receiving antenna functions 49, 50, 51, 52, 53 is indicated with arrows 58, 59, 60 for a first receiving antenna function 49, and the transmitting ability for the transmitting antenna functions 54, 55, 56, 57 is indicated with arrows 58′, 59′, 60′ for a first transmitting antenna function 54. Although only denoted with reference signs for one antenna function of a kind 49, 54 for increased clarity, this configuration is applied for all antenna functions. It should be noted that there normally are more cells and antenna functions in a cellular network than those shown, FIG. 6 and FIG. 7 only showing a part for reasons of clarity.

Note that this illustration is highly idealized in that all cells have identical size and layout. In a real system, local geographical variations and user terminal density will lead to a heterogeneous cell layout.

If baseband interference cancellation is utilized in uplink, then the cancellation will be considerably simplified and improved if the downlink transmitted signal is known. If these signals are not known in advance, the downlink signal can also be equalized and detected before cancellation and uplink detection.

All these signals between downlink and uplink are very delay sensitive with strict delay constraints. It is thus beneficial if the downlink transmitter and uplink receiver are placed in the same device. As an example, the processing of several nodes can be placed in a central processing unit 61 connected to the antenna functions 49, 50, 51, 52, 53; 54, 55, 56, 57 via connections 62 as shown in FIG. 6.

Alternatively, the downlink transmitter and uplink receiver can be placed in separate devices with a high speed communication interface as indicated with dashed lines 63 in FIG. 7.

Examples of alternatives of the information distributed over this link are listed below.

One device contains baseband processing for both receiver and transmitter, for a specific cell, such that antenna signals are distributed over the high speed communication link.

Baseband processing for transmitter and receiver, for a specific cell, are placed in separate devices. The high speed interface must then contain uplink and downlink ACK, scheduling decisions, etc. If interference cancellation is used, this high speed communication link can also contain coded or un-coded user data transmitted in downlink. Then, the bandwidth requirement on the high speed interface is significantly lower than if antenna signals are distributed.

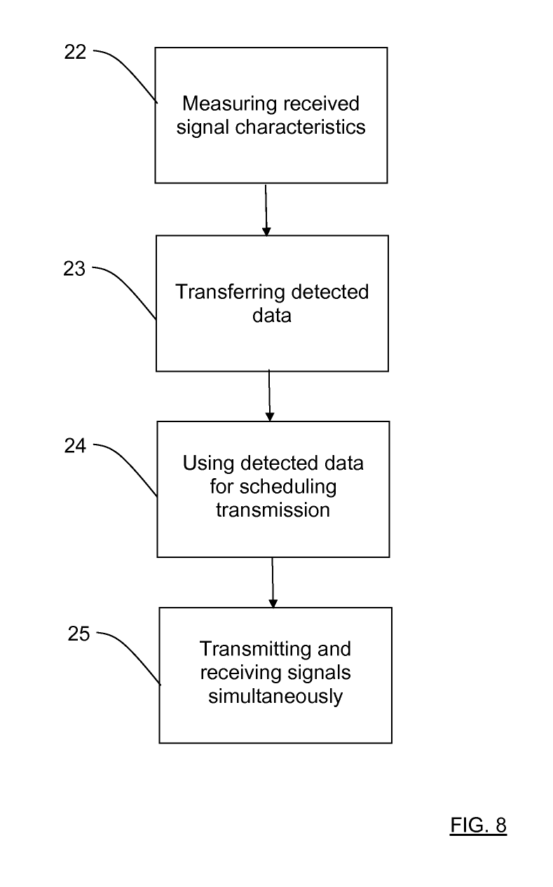

With reference to FIG. 8, the present invention also relates to a method in a wireless communication network 3. The method comprises the steps:

22: At least one user terminal 1 in the wireless communication network 3 measuring received signal characteristics from at least one other user terminal 4, 5 when said other user terminal 4, 5 is transmitting signals 6, 7; 8, 9, where the measured received signal characteristics is comprised in measurement data.
23: Transferring the measurement data to at least one node 2 in the wireless communication network 3.
24: Using the measurement data for scheduling transmission of signals 10, 11, 12 and reception of signals 6, 8, 13 from and to said node 2 such that each user terminal 1, 4, 5 that communicates via said node 2 either transmits signals 6, 8, 13 to said node 2 using a first frequency interval or receives signals 10, 11, 12 from said node 2 using the first frequency interval.
25: The node 2 transmitting signals 10, 11, 12 and receiving signals 6, 8, 13 simultaneously using the first frequency interval.

The present invention is not limited to the described examples above, but may vary freely within the scope of the appended claims. For example, any number of user terminals, even all user terminals, within a wireless communication network may be equipped for measuring received signal characteristics from at least one other user terminal.

An antenna function may comprise one or more antennas, each antenna comprising one or more antenna elements.

Instead of a base station there may be any suitable node such as a repeater station.

The present invention is applicable for any type of wireless communication network.

The user terminals mentioned may for example be constituted by mobile phones and/or laptops.

Although specific terms may be employed in the description, they are used in a generic and descriptive sense only and not for purposes of limitation.

1-15. (canceled)

16. A user terminal configured for communication with at least one node in a wireless communication network, the user terminal being arranged to measure received signal characteristics from at least one other user terminal when said other user terminal is transmitting signals, the measured received signal characteristics being comprised in measurement data, where furthermore the user terminal is arranged to transfer the measurement data to said node at certain times.

17. The user terminal according to claim 16, wherein said user terminal is arranged to gather information for identification of said other user terminal, said information being comprised in the measurement data.

18. The user terminal according to claim 16, wherein the user terminal is arranged to perform a self-configuration procedure based on the measurement data.

19. The user terminal according to claim 16, wherein the transferred measurement data enables said node to schedule its transmission of signals and reception of signals such that each user terminal that communicates via said node either transmits signals to said node at a first frequency interval or receives signals from said node at the first frequency interval, said node being arranged to transmit signals and receive signals simultaneously at the first frequency interval.

20. The user terminal according to claim 16, wherein the signal characteristics is constituted by at least one of signal strength, signal spatial characteristics and signal temporal characteristics.

21. A node in a wireless communication network, said node being arranged to schedule its transmission of signals and reception of signals such that each user terminal that communicates via the node either transmits signals to the node at a first frequency interval or receives signals from the node at the first frequency interval, the node being arranged to transmit signals and receive signals simultaneously at the first frequency interval.

22. The node according to claim 21, wherein the scheduling comprises division of the user terminals that communicate via the node into at least two groups, where at least one user terminal in one group is scheduled to only transmit signals and at least one user terminal in another group is scheduled to only receive signals.

23. The node according to claim 22, wherein the scheduling is based on measurement data received from at least one user terminal, the measurement data being measured by said user terminal and comprising received signal characteristics from at least one other user terminal when said other user terminal is transmitting signals.

24. The node according to claim 23, wherein the signal characteristics is constituted by at least one of signal strength, signal spatial characteristics and signal temporal characteristics.

25. The node according to claim 23, wherein the measurement data comprises information that enables the node to identify said other user terminal.

26. The node according to claim 21, wherein the node further comprises at least a first antenna function and a second antenna function, the antenna functions being arranged for transmitting signals and receiving signals in controllable spatial directions.

27. The node according to claim 26, wherein the antenna functions that are arranged to transmit signals are physically separated from those antenna functions that are arranged to receive signals.

28. A method in a wireless communication network, comprising:
at least one user terminal in the wireless communication network measuring received signal characteristics from at least one other user terminal when said other user terminal is transmitting signals, the measured received signal characteristics being comprised in measurement data;
transferring the measurement data to at least one node in the wireless communication network;
using the measurement data for scheduling transmission of signals and reception of signals from and to said node such that each user terminal that communicates via said node either transmits signals to said node using a first frequency interval or receives signals from said node using the first frequency interval, and
said node transmitting signals and receiving signals simultaneously using the first frequency interval.

29. The method according to claim 28, wherein the measurement data is used for identification of said other user terminal.

30. The method according to claim 28, further comprising dividing the user terminals that communicate via the node into at least two groups, where at least one user terminal in one group is scheduled to only transmit signals and at least one user terminal in another group is scheduled to only receive signals.
